(19) United States
(12) Patent Application Publication
(10) Pub. No.: US 2010/0027444 A1
(43) Pub. Date: Feb. 4, 2010

(54) METHOD AND SYSTEM FOR ESTABLISHING CONNECTIONS FOR WIRELESS NETWORK DEVICES

(75) Inventors: Yi Lin, Hsinchu (TW); Wu-Yao Chuang, Hsinchu (TW)

Correspondence Address: EDWARDS ANGELL PALMER & DODGE LLP, P.O. BOX 55874, BOSTON, MA, 02205, US

(73) Assignee: RALINK TECHNOLOGY CORPORATION, Hsinchu (TW)

(21) Appl. No.: 12/431,816

(22) Filed: Apr. 29, 2009

(30) Foreign Application Priority Data
Jul. 30, 2008 (TW) 097128745

(51) Int. Cl. H04W 76/02

(52) U.S. Cl. 370/254

(57) ABSTRACT

A method and system for establishing a connection for a wireless network device is provided. It allows a station to send a trigger signal to a multimedia receiving device. Upon receiving the trigger signal, the multimedia receiving device is prompted to reply to the station with a response signal. Upon receiving the response signal, the station is prompted to clone an identity information of the multimedia receiving device as its own identity information. The station is then allowed to be connected with a wireless network access device. By this way, the time for cloning the identity information of the multimedia receiving device in the station can be shortened, thus the overall connection establishment time can be reduced after the wireless network device is restarted.

### FIELD OF THE INVENTION

The present invention relates to a method and system for establishing connections for wireless network devices, and more particularly, to a method and system for establishing connections for wireless network devices to speed up the process for cloning an identity information.

### BACKGROUND OF THE INVENTION

Network technologies have become the most economical and widespread media for delivering messages as they thrive. While the network is getting increasingly relied on, the application convenience has become highly valued. With the improvement in the network technologies, more and more data can be transferred over the network. As a result, a larger network bandwidth is desired, especially for transmitting multimedia data. Accordingly, a multicast technology has been proposed. Multicast is a way to deliver data only to the members of a certain group. These members are distributed across different networks but listen to the same multicast address. Thus, compared to the conventional one-to-one unicast communication system, multicast is more efficient in terms of using network bandwidths and IP addresses.

In order to implement the multicast technology, a protocol called IGMP (Internet Group Management Protocol) has been developed. IGMP essentially uses the IP stack to realize the multicast communication system, which presents saving the bandwidth usage as the greatest advantage. The IP stack is consisted of several different layers, and each of them only communicates with the layers immediately above and below it. IGMP specifically uses the second layer (the data link layer) and the third layer (the communication layer). The multicast feature enables an efficient video stream transmission over the broadband network. According to IGMP, all the hosts that make data requests are able to receive the data streams. However, these requests will not be transmitted to the primary server. Besides, the data streams are cloned in the required multicast routers only instead of in the primary server, thereby being able to reduce the bandwidth consumption.

Typically, the digital audio/video (AV) service providers utilize the above techniques. For example, a digital AV service provider may connect with a receiving device (such as a set-top box) at the client end over an Ethernet system for delivering real-time AV services.

However, the Ethernet system is a cable network with drawbacks in inconvenient architecture layout and limited application. Thus, wireless network technologies have been developed and put into use. The main difference between a wireless network and a cable network lies in the media for data transmission. The former uses wireless electrical waves as the media to transmit data, while the latter requires physical cables. Therefore, the wireless network is much more convenient and mobile in both deployment and application over the cable network.

In the wireless network, data transmission usually involves establishing a connection by a wireless network transceiver system. Such system includes at least an access point (AP) and a station. The AP is typically connected with a network router, and the station is connected with a multimedia receiving device, such as a set-top box. Since the connection between the AP and the station is achieved by wireless electrical waves, it is not bound to physical cables for the client end to receive multimedia data. However, there are some derived issues to be discussed as follows.

First, a multimedia data provider at the server end has to validate that the multimedia receiving device is an authenticated user by checking its MAC address before transmitting any multimedia data. Thus, a MAC address cloning process has to be carried out between the station and the multimedia receiving device. In order to allow the multimedia data provider to validate the multimedia receiving device as an authenticated user, the station has to clone the MAC address of the multimedia receiving device as its own MAC address in addition to the original MAC address.

In a traditional MAC address cloning process, the AP and the station have to establish a connection first so that a DHCP (Dynamic Host Configuration Protocol) server can send a message to the multimedia receiving device to obtain an IP address. Upon receiving the DHCP message, the multimedia receiving device will send a First DHCP Discovery frame to the station to enable the station to perform the aforementioned MAC address cloning.

However, some problems may occur if the AP or the station is turned off before restarted again :

(1) Since the connection between the AP and the station is not yet established, the multimedia receiving device cannot receive messages from the DHCP server. It makes the MAC address cloning in the station not possible, thereby increasing the connection time.

(2) After the station has completed the MAC address cloning, the AP will discover that the MAC address of the station is different from the earlier established one. It is resulted from that the current MAC address of the station has been modified. Consequently, a disconnection will occur. In the case, the station has to re-establish the connection with the AP, causing a waste of time.

Therefore, it is desired to provide a method and system that reduces the time needed for establishing the connections in the wireless network.

### SUMMARY OF THE INVENTION

In the light of forgoing drawbacks, the present invention provides a method for establishing a connection for a wireless network device applicable to a wireless network system including a wireless network access device, a station and a multimedia receiving device, the method including: (1) allowing the station to send an trigger signal to the multimedia receiving device; (2) upon receiving the trigger signal, allowing the multimedia receiving device to reply to the station with a response signal; (3) upon receiving the response signal, allowing the station to clone an identity information of the multimedia receiving device as its own identity information; and (4) allowing the station to establish the connection with the wireless network access device.

The present invention further provides a wireless network system including a multimedia receiving device; a station connected with the multimedia receiving device; and a wireless network access device connected with the station through wireless electrical waves, wherein the station autonomously sends an trigger signal to the multimedia receiving device replying to the station with a response signal upon receiving the trigger signal, clones an identity information of the multimedia receiving device as its own identity information upon receiving the response signal, and establishes a connection with the wireless network access device.

According to the method and system of the present invention, the station autonomously sends the trigger signal to the multimedia receiving device, enabling the multimedia receiving device to reply with a response signal to clone MAC addresses. Even if the station is not connected with the wireless network access device, the station can still clone the MAC addresses. Therefore, the time that the station of the prior art wastes to wait the first DHCP Discovery messages is reduced, and the station has cloned the MAC addresses before connecting to the wireless network access device, such that the above problem that the AP discovers that this MAC address of the station is different from that established earlier is solved and the time that a user has to wait when powering on the device.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart illustrating a method for establishing connection for a wireless network device according to one embodiment of the present invention;

FIG. 2 is a flowchart illustrating the method for establishing a connection for a wireless network device according to another embodiment of the present invention;

FIG. 3 is a schematic diagram depicting a system 1 for establishing a connection for a wireless network device according to an embodiment of the present invention; and

FIG. 4 is a schematic diagram depicting an application of the system for establishing a connection for a wireless network device according to a preferred embodiment of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

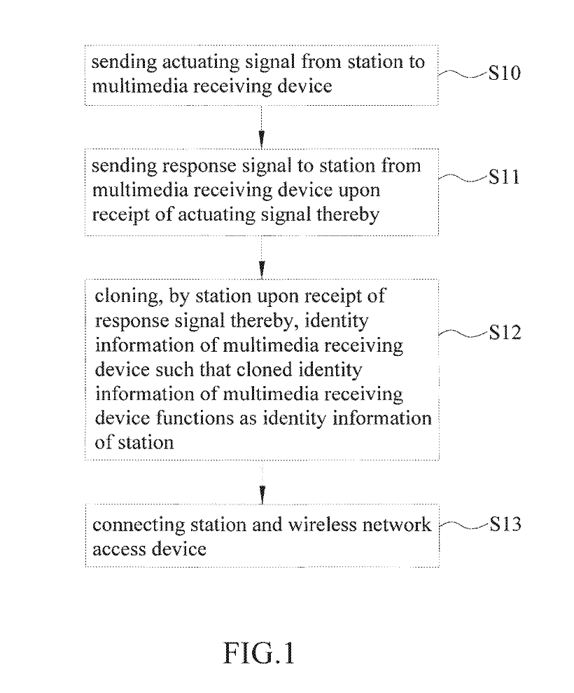

Referring to FIG. 1, a flowchart illustrating a method for establishing connection for a wireless network device according to one embodiment of the present invention is shown. The method for establishing connection for a wireless network device according to one embodiment of the present invention is applied in a wireless network system that includes a multimedia receiving device and a station connected to the multimedia receiving device. According to an embodiment of the present invention, the multimedia receiving device is a set-top box, for example. The station is a wireless network card connected to the multimedia receiving device for wirelessly communicating with a wireless network access device, thereby enabling the multimedia receiving device to receive/transmit multimedia data over the wireless network system. The method for establishing connection for a wireless network device according to one embodiment of the present invention includes the steps as follows.

In step S10, the station sends an trigger signal to the multimedia receiving device. In a wireless network system, the station can be a wireless network card, and the trigger signal is a data packet with specifications that conform with a certain network communication protocol being used. For example, multimedia data transmission usually uses multicast, and an IP management method that is suited for multicast is a protocol called IGMP. Under such infrastructure, the station sends an authenticated IGMP inquiry packet as the trigger signal to the multimedia receiving device. Then, step S11 is performed.

In step S11, upon receiving the trigger signal, the multimedia receiving device returns a response signal back to the station. Specifically, the response signal returned by the multimedia receiving device is a data packet that has specifications corresponding to that in step S10. For example, if the trigger signal is an authenticated IGMP inquiry packet, then the response signal is also an authenticated IGMP response packet.

In step S12, upon receiving the response signal, the station clones the identity information of the multimedia receiving device as its own identity information. Since the response signal includes the identity information of the multimedia receiving device, the station may extract this information and cloning it as its own. Specifically, in multimedia transmission system, a server that provides AV services will perform an identity verification to the multimedia receiving device at the other end. This check usually involves the identification of the MAC address of the multimedia receiving device to determine if it is an authenticated user. Since the station has its own MAC address, it must clone the MAC address of the multimedia receiving device as its own MAC address for a successful authentication by the server of the AV service provider. This action is MAC address cloning.

In step 13, the station is prompted to establish a connection with the wireless network access device. The wireless network access device in the wireless network system can be, for example, but not limited to a wireless network base station and/or a wireless router. The station actively establishes a connection with the wireless network access device.

More specifically, in the method for establishing a connection for a wireless network device, the step for establishing a connection between a station and a wireless network access point further includes: the station scanning to determine whether a wireless network access device exists, and going to the next step if the wireless network access device exists or repeating this step if the wireless network access device does not exist; the wireless network access device performing an identify check on the station; and the wireless network access device connecting with the station if the identity verification was valid. For example, in the wireless network system, the wireless network card has to do a network scan before connection to find an available wireless network access device (e.g. a base station) within its connection range. The wireless network base station will usually set an authentication or encryption process to prevent unauthorized attempts to connect. Thus, the wireless network card has to undergo the identity verification before establishing a connection with the wireless network access device.

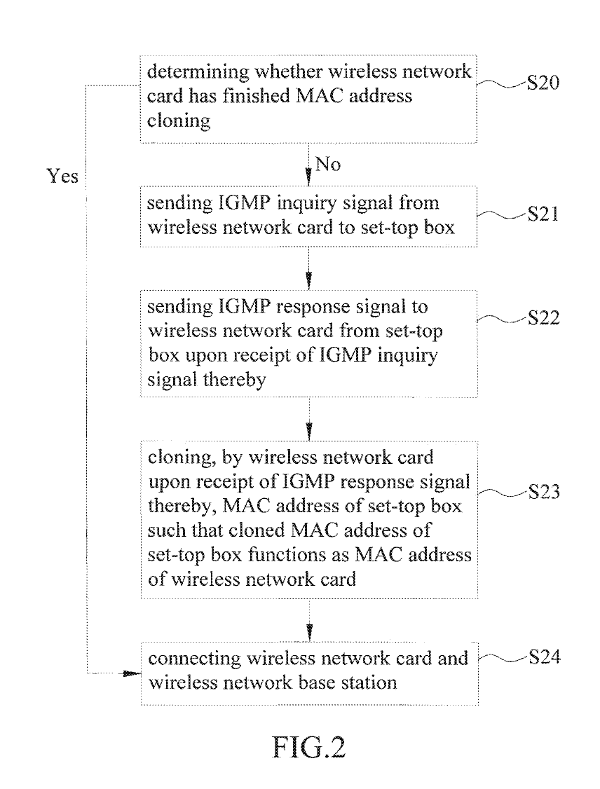

Referring to FIG. 2, a flowchart illustrating the method for establishing a connection for a wireless network device according to another embodiment of the present invention is shown. In this embodiment, the method for establishing a connection for a wireless network device is applied in a wireless network system. The wireless network system includes a wireless network card, a wireless network base station and a set-top box.

In step S20, it is determined whether the wireless network card has finished MAC address cloning, in order to determine the time for sending an trigger signal. If the wireless network card has finished MAC address cloning, which implies the wireless network card has already connected to the set-top box, step S24 is performed; else, step S21 is performed.

In step 21, the wireless network card autonomously sends an IGMP inquiry signal to the set-top box. Then, step S22 is performed.

In step 22, the set-top box returns an IGMP response signal to the wireless network card after receiving the IGMP inquiry signal. Since the wireless network card sends an authenticated IGMP inquiry signal, the set-top box will think that inquiry signal is sent from the multimedia server and returns an IGMP response signal to the multimedia server. Then, step S23 is performed.

In step 23, upon receiving the response signal, the wireless network card clones the MAC address of the set-top box as its own MAC address. Then, step S24 is performed.

In step 24, the wireless network card and the wireless network base station carry out a connection procedure.

According to this embodiment of the present invention, the wireless network card autonomously sends the IGMP inquiry signal to the set-top box without having to wait for the First DHCP Discovery frame like in the prior art, and performs MAC address cloning based on the IGMP response signal from the set-top box. Furthermore, the MAC address cloning occurs before connection of the wireless network card and the wireless network base station, thus avoiding breaking of connection between the wireless network card and the wireless network base station due to MAC address cloning in the prior art.

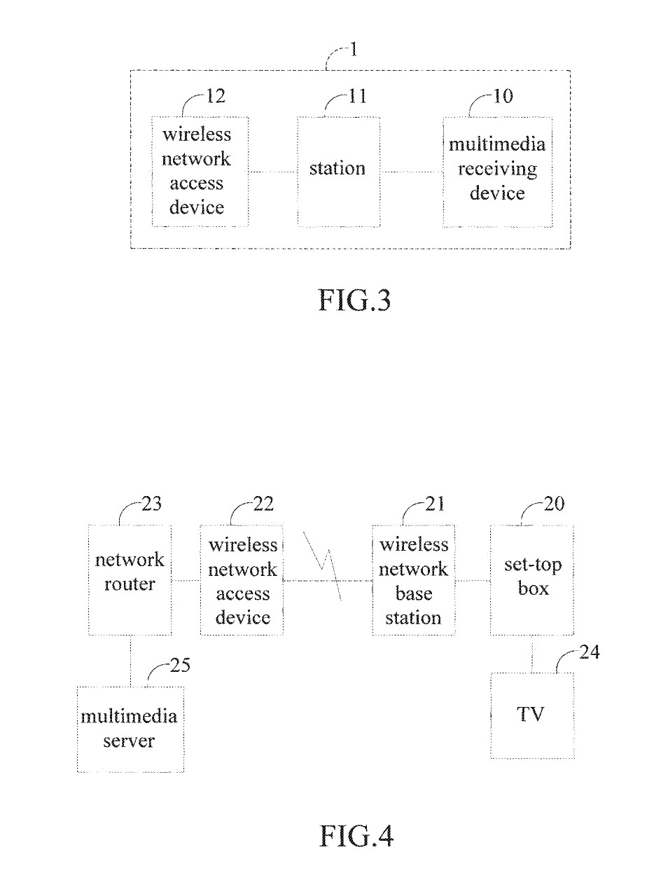

Referring to FIG. 3, a schematic diagram depicting a system 1 for establishing a connection for a wireless network device according to an embodiment of the present invention is shown. The system 1 includes a multimedia receiving device 10, a station 11 connected with the multimedia receiving device 10, and a wireless network access device 12 connected to the state via a wireless link.

The multimedia receiving device 10 is for receiving multimedia data. The multimedia receiving device 10 is an end device in the network connection system. More specifically, the multimedia receiving device 10 can be a set-top box in a domestic multimedia apparatus for outputting the received multimedia data to a television.

The station 11 is for receiving and transmitting data over the wireless network, which can be a wireless network card, for example. According to an embodiment of the present invention, the station 11 connects with the multimedia receiving device 10, and transmits data using wireless electrical waves, such that there is no need for physical network cables. This facilitates a convenient usage environment.

The wireless network access device 12 is used for providing the wireless network, such that the station 11 connects and transmits data to the wireless network access device 12. The wireless network access device 12 can, for example, be a wireless network base station and/or wireless router. More specifically, the wireless network access device 12 connects with a broadband network or multimedia server via an Ethernet cable, for example. The station 11 communicates with the wireless network access device 12 based on certain wireless network protocols (e.g. 2.4 GHz frequency of 802.11b/g).

According to the above, the station 11 autonomously sends an trigger signal to the multimedia receiving device 10. When the multimedia receiving device 10 receives the trigger signal, it replies with a response signal to the station 11. Upon receiving the response signal, the station 11 then uses the received identity information as its own identity information and connects with the wireless network access device 12.

In a preferred embodiment, the trigger signal is an authenticated IGMP inquire packet and the response signal is an authenticated IGMP response packet.

In another preferred embodiment, the identity information is a MAC address. The station 11, after receiving the response signal, clones the MAC address of the multimedia receiving device 10 as its own MAC address. This action is called MAC address cloning.

In yet another preferred embodiment, the wireless network access device 12 has an IGMP snooping function, which provides data to the station in a unicast manner. When receiving unicasted data, the station 11 replies with an acknowledgment. As such, the IGMP snoop function allows the multimedia server to determine whether the multimedia receiving device has received the data it sent.

Referring to FIG. 4, a schematic diagram depicting an application of the system for establishing a connection for a wireless network device according to a preferred embodiment of the present invention is shown. In this embodiment, a set-top box 20 is a user end apparatus for receiving encoded and/or compressed signals and decoding and/or decompressing the signals. The user end can send emails or used in cooperation with a television. Normally, a set-top box 20 is used for providing integrated AV signals to a digital television.

The wireless network card 21 and the wireless network base station 22 are necessary components in a wireless network system. The wireless network base station 22 sends wireless electrical waves within a certain range. The wireless network card 21 is able to connect with the wireless network base station 22 within this range for data transmission or reception. As shown in FIG. 4, the wireless network card 21 and the wireless network base station 22 are used as interface for receiving AV signals by the set-top box 20.

In this embodiment, when a user wishes to watch multimedia information, the desired data including the multimedia data the user wishes to watch is transmitted to the set-top box 20 over a wireless network via a network router 23, which is connected to a broadband network or other information providing servers, such as a multimedia server 25. Then, the set-top box 20 decodes and outputs the information to a television 24, which then displays the multimedia information.

According to an embodiment of the present invention, if a user wishes to watch a multimedia program using TV 24, he/she must turn on the set-top box 20, the wireless network card 21 and the wireless network base station 22. Since the booting time for the wireless network card is usually shorter than the wireless network base station, so as the wireless network card 21 is booted, it immediately sends an IGMP inquiry packet to the set-top box 20. Even if the set-top box takes a long time to boot, the set-top box may reply a IGMP response packet before booting is completed to the wireless network card 21 after receiving the authenticated inquiry packet. At this point, the wireless network card 21 may obtain the MAC address of the set-top box 20 in order to perform MAC address cloning.

After MAC address cloning, the wireless network card connects with the wireless network base station 22. After the network router 23 validates the MAC address of the wireless network card 21 (actually of the set-top box 20), the multimedia server 25 begins transmitting multimedia data for the user to watch.

According to the above, the wireless network card 21 will keep sending trigger signals (IGMP inquiry packets) to the set-top box 20 before MAC address cloning is performed. Thus, the wireless network card 21 does not waste any time to perform MAC address cloning. In addition, the wireless network card 21 connects with the wireless network base station 22 only after the MAC address has been cloned, to avoid re-establishment of network connection between the wireless network card 21 and the wireless network base station 22.

With the method and system for establishing a connection for a wireless network device of the present invention, the following advantages can be achieved.

(1) The time for MAC address cloning in the wireless network card is reduced. Compared to the prior art, where the wireless network card has to wait for the first DHCP discovery frame from the set-top box, the wireless network card can complete MAC address cloning without waiting for the first DHCP discovery frame. The present invention achieves this effect by allowing the wireless network card to autonomously send trigger signals that facilitates MAC address cloning, disregard the type of set-top box used.

(2) Re-establishment of connection between the wireless network card and the wireless network base station is eliminated. Compared to the prior art, where the set-top box has to obtain an IP address from the DHCP server, the wireless network card and the wireless network base station will need to establish a connection first. But after the wireless network card clones the MAC address, the wireless network base station detects this new MAC address, and as a result, disconnects with the wireless network card. In the present invention, the wireless network card does not need to wait for first DHCP discovery frame, so there is no need for prior connection between the wireless network card and the wireless network base station. The connection is made only after the wireless network card has cloned the MAC address. This eliminates re-establishment of connection and saves time.

In conclusion, the method and system for establishing a connection for a wireless network device of the present invention is able to reduce the connection time during boot-up of a user end device. This raises the competitiveness and commercial value of the multimedia apparatus incorporating the method and system for establishing a connection for a wireless network device of the present invention.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for establishing a connection in a wireless network system, the method comprising:
(1) exchanging an trigger signal and a response signal between a station and a multimedia receiving device;
(2) cloning an identity information from the multimedia receiving device as the identity information of the station; and
(3) establishing a connection between the station and a wireless network access device.

2. The method of claim 1, wherein the wireless network access device is a wireless network base station, a wireless access point or a wireless router.

3. The method of claim 1, wherein the station is a wireless station.

4. The method of claim 1, wherein the multimedia receiving device is a set-top box.

5. The method of claim 1, wherein the trigger signal is an authenticated IGMP inquiry packet.

6. The method of claim 1, wherein the response signal is an authenticated IGMP response packet.

7. The method of claim 1, wherein the identity information is a MAC address.

8. The method of claim 1, wherein step (3) further comprises:
(3-1) allowing the station to scan and determine whether the wireless network access device exists, and performing step (3-2) if the wireless network access device exists, or else repeating step (3-1);
(3-2) allowing the station to perform an identity verification with the wireless network access device; and
(3-3) allowing the station to establish the connection with the wireless network access device.

9. A wireless network system, comprising:
a multimedia receiving device;
a station connected with the multimedia receiving device; and
a wireless network access device wirelessly connected with the station,
wherein the station and the multimedia receiving device exchange an trigger signal and a response signal, the station clones an identity information from the multimedia receiving device as the identity information of the station, and the station establishes a connection with the wireless network access device.

10. The wireless network system of claim 9, wherein the wireless network access device has an IGMP snooping function that provides data to the station in a unicast manner.

11. The wireless network system of claim 9, wherein the wireless network access device is a wireless access point or a wireless router.

12. The wireless network system of claim 9, wherein the station is a wireless network card or a wireless station.

13. The wireless network system of claim 9, wherein the multimedia receiving device is a set-top box.

14. The wireless network system of claim 9, wherein the trigger signal is an authenticated IGMP inquiry packet.

15. The wireless network system of claim 14, wherein the response signal is an authenticated IGMP response packet.

16. The wireless network system of claim 9, wherein the identity information is a MAC address.
